(19) United States
(12) Patent Application Publication
(10) Pub. No.: US 2016/0110503 A1
(43) Pub. Date: Apr. 21, 2016

(54) ELECTRONIC MEDICAL RECORDS SYSTEM-BASED APPARATUS FOR MANAGING SUMMARY SHEET, AND METHOD FOR MANAGING SAME

(71) Applicant: SEOUL NATIONAL UNIVERSITY BUNDANG HOSPITAL, Gyeonggi-do (KR)

(72) Inventors: Chin Youb CHUNG, Gyeonggi-do (KR); Rong Min BAEK, Seoul (KR); Hee HWANG, Daejeon (KR); Kee Hyuck LEE, Gyeonggi-do (KR); Soo Young YOO, Gyeonggi-do (KR); Jong Hoar YOON, Gyeonggi-do (KR)

(73) Assignee: SEOUL NATIONAL UNIVERSITY BUNDANG HOSPITAL, Gyeonggi-do (KR)

(21) Appl. No.: 14/787,182

(22) PCT Filed: Apr. 21, 2014
(86) PCT No.: PCT/KR2014/003458

§ 371 Date: Oct. 26, 2015

(30) Foreign Application Priority Data
Apr. 25, 2013 (KR) 10-2013-0045979

(51) Int. Cl. G06F 19/00

(52) U.S. Cl. CPC G06F 19/322

(57) ABSTRACT

The present invention relates to an electronic medical record system-based apparatus and method for managing summary sheets that, in an electronic medical record system, extract important information from patient information in accordance with a summary sheet configuration set in advance, display the extracted information in a single summary sheet, and thus enable important patient information to be checked in an integrated manner.

### TECHNICAL FIELD

The present invention relates to technology for managing a summary sheet in an electronic medical record system, and more particularly to an electronic medical record system-based apparatus and method for managing summary sheets that, in an electronic medical record system, extract important information from patient information in accordance with a summary sheet configuration set in advance, display the extracted information in a single summary sheet, and thus enable important patient information to be checked in an integrated manner.

### BACKGROUND ART

In general, an Electronic Medical Record (EMR) system is a medical information system that combines a conventional method of managing medical records using paper charts with IT technology and computerizes medical information generated in a hospital. In this EMR system, health status information, such as an individual patient-based medical history, the status of the administration of medicine, test results, etc., can be easily input and stored. As described in Korean Patent No. 10-0538579 (published on Dec. 16, 2005), technology that enables information to be changed into a form that is convenient to a user is disclosed.

Although a user is allowed to basically select a sheet form displayed on a web screen in an EMR system via conventional technology, this EMR form is based on a method of individually inquiring about a medical record, an order issuance, and test result information using a menu. Accordingly, this method has a problem in that it is difficult for a medical staff member to check the important content of patient information in an integrated manner.

Furthermore, in the case of a patient who suffers from two or more illnesses or diseases or a patient who has been treated in a hospital for a long period of time, there may be a plurality of medical staff members who have issued orders. Since there is no technology that enables each medical staff member to extract only the content of orders issued by himself or herself and provides the extended content, inconvenience arises in that it is necessary to inquire about the content of an order issuance from patient information a plurality of times.

Accordingly, there is a demand for the function of providing a summary sheet that can extract important content from patient information and provide the extracted content in a single inquiry window, and selecting and changing the content of a summary sheet for each medical staff member.

### DISCLOSURE

### Technical Problem

Accordingly, the present invention is proposed to overcome the above-described problems of the conventional art, and an object of an EMR system-based apparatus for managing summary sheets according to the present invention is to provide a summary sheet that displays the important content of patient information in a single task window in a patient information inquiry window.

Another object of the present invention is to activate a summary sheet using a specific icon in a patient information inquiry window.

Still another object of the present invention is to display the page information of a summary sheet, each page-based content information and detailed information in a single task window using a summary sheet display unit.

Still another object of the present invention is to change the setting of the display magnification of a summary sheet and rearrange and provide the content of the summary sheet in accordance with each display magnification.

Still another object of the present invention is to further include an environment setting unit and change the setting of the display environment of a summary sheet.

Still another object of the present invention is to further include a summary sheet information unit and store and manage patient information and summary sheet environment information.

An object of an EMR system-based method of managing summary sheets according to the present invention is to extract information from patient information in accordance with the set environmental conditions of a summary sheet and display and provide the extracted content of the summary sheet upon request for the activation of the summary sheet.

Another object of the present invention is to apply summary sheet environment information set in an administrator setting section or individual setting section.

Still another object of the present invention is to rearrange and display the content of a summary sheet in accordance with selected display magnification when display magnification is changed.

Still another object of the present invention is to display the page information of a summary sheet, each page-based content item, and the details of summary content in a single task window.

### Technical Solution

An electronic medical record (EMR) system-based apparatus for managing summary sheets according to the present invention includes a summary sheet activation unit formed on one side of a patient information inquiry window of an EMR system, and configured to request the activation of a summary sheet; a summary sheet control unit configured to control the task of displaying the summary sheet and the task of setting the summary sheet in response to the request for the activation of the summary sheet; a summary sheet configuration unit configured to extract the content of the summary sheet from patient information in accordance with the setting of the summary sheet; and a summary sheet display unit configured to display the content of the summary sheet, extracted by the summary sheet configuration unit, in a popup window form.

An electronic medical record (EMR) system-based method of managing summary sheets according to the present invention includes the steps of: (a) setting the configuration environment of a summary sheet using an environment setting unit; (b) upon inquiry about patient information, extracting patient information and configuring a summary sheet in accordance with the environmental conditions set at step (a); (c) requesting the activation of a display window for the summary sheet using a summary sheet activation unit in a screen in which the patient information has been inquired about; and (d) displaying the summary sheet configured at step (b) using a summary sheet display unit.

### Advantageous Effects

As described above, the EMR system-based apparatus for managing summary sheets according to the present invention provides a summary sheet that displays the important content of patient information in a single task window in a patient information inquiry window, thereby providing the effect of enabling a medical staff member to check the important content of patient information in an EMR system in an integrated manner and also facilitating the task of inquiring patient information and order issuance content.

Furthermore, the present invention conveniently activates a summary sheet using a specific icon in a patient information inquiry window, thereby providing the effect of improving the convenience of a medical staff member who uses a summary sheet.

Furthermore, the present invention displays the page information of a summary sheet, each page-based content information and detailed information in a single task window using a summary sheet display unit, thereby providing the effect of facilitating a page-based or content-based selection task and also enabling detailed information to be immediately checked.

Furthermore, the present invention rearranges the content of a summary sheet in accordance with each display magnification, thereby providing the effect of enabling a medical staff member to easily check summary content.

Furthermore, the present invention changes the setting of the display environment of a summary sheet, thereby providing the effect of enabling the personalization of the summary sheet.

Furthermore, the present invention provides the effect of systematically storing and managing patient information and summary sheet environment information.

EMR system-based method of managing summary sheets according to the present invention extracts information from patient information in accordance with the set environmental conditions of a summary sheet and displays and provides the extracted content of the summary sheet upon request for the activation of the summary sheet, thereby providing the effect of considerably improving the efficiency of the management of a summary sheet.

Furthermore, the present invention applies summary sheet environment information set in an administrator setting section or an individual setting section, thereby providing the effect of facilitating the sharing of a generic summary sheet or the configuration of a summary sheet customized for each individual.

Furthermore, the present invention rearranges and displays the content of a summary sheet in accordance with selected display magnification when display magnification is changed, thereby providing the effect of improving the information identification of a medical staff member.

Furthermore, the present invention displays the page information of a summary sheet, each page-based content item and the details of summary content in a single task window, thereby providing the effect of checking the important information of a patient in an integrated manner without the task of individually inquiring the important information of the patient.

### DESCRIPTION OF DRAWINGS

FIG. 1 is a diagram showing the overall configuration of an EMR system-based apparatus for managing summary sheets according to the present invention;

FIG. 2 is an embodiment screen showing the operation of displaying a summary sheet in response to the selection of an activation icon in an EMR system-based apparatus for managing summary sheets according to the present invention;

FIG. 3 is a diagram showing the detailed configuration of a summary sheet display unit in an EMR system-based apparatus for managing summary sheets according to the present invention;

FIG. 4 is a first embodiment screen of a summary sheet in an EMR system-based apparatus for managing summary sheets according to the present invention;

FIG. 5 is a second embodiment screen of a summary sheet in an EMR system-based apparatus for managing summary sheets according to the present invention;

FIG. 6 is an embodiment screen showing the displayed content of a summary sheet based on the selection of a display magnification setting unit in an EMR system-based apparatus for managing summary sheets according to the present invention;

FIG. 7 is a diagram showing the detailed configuration of an environment setting unit in an EMR system-based apparatus for managing summary sheets according to the present invention;

FIG. 8 is a diagram showing the configuration of an administrator setting section in an EMR system-based apparatus for managing summary sheets according to the present invention;

FIG. 9 is an embodiment screen showing the configuration of an administrator setting section in an EMR system-based apparatus for managing summary sheets according to the present invention;

FIG. 10 is a diagram showing the configuration of an individual setting section in an EMR system-based apparatus for managing summary sheets according to the present invention;

FIG. 11 is an embodiment screen showing the configuration of an individual setting section in an EMR system-based apparatus for managing summary sheets according to the present invention;

FIG. 12 is a diagram showing an embodiment screen of a content information region section in an EMR system-based apparatus for managing summary sheets according to the present invention; and

FIG. 13 is a flowchart showing the overall flow of an EMR system-based method of managing summary sheets according to the present invention.

### BEST MODE

Specific details that are required to practice an EMR system-based apparatus and method for managing summary sheets according to the present invention will be described as follows.

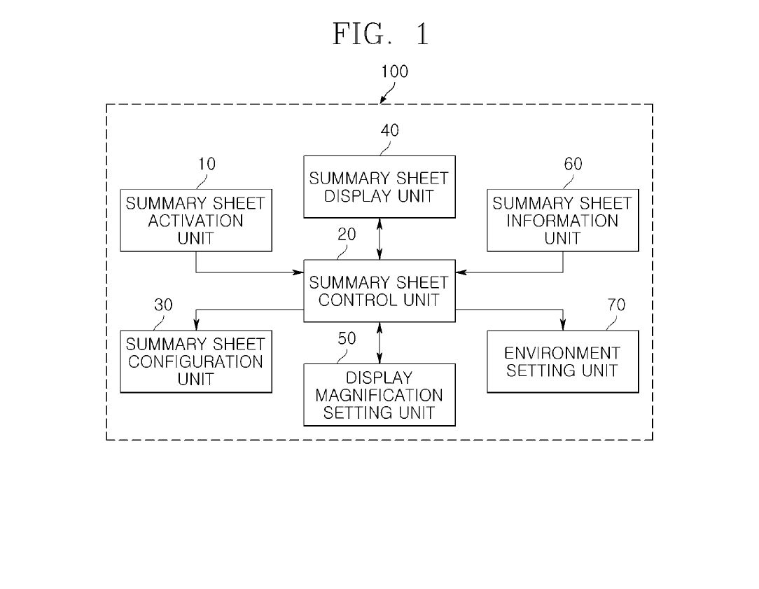

FIG. 1 is a diagram of the overall configuration of an EMR system-based apparatus for managing summary sheets according to the present invention, which includes a summary sheet activation unit 10, a summary sheet control unit 20, a summary sheet configuration unit 30, a summary sheet display unit 40, a display magnification setting unit 50, summary sheet information unit 60, and an environment setting unit 70.

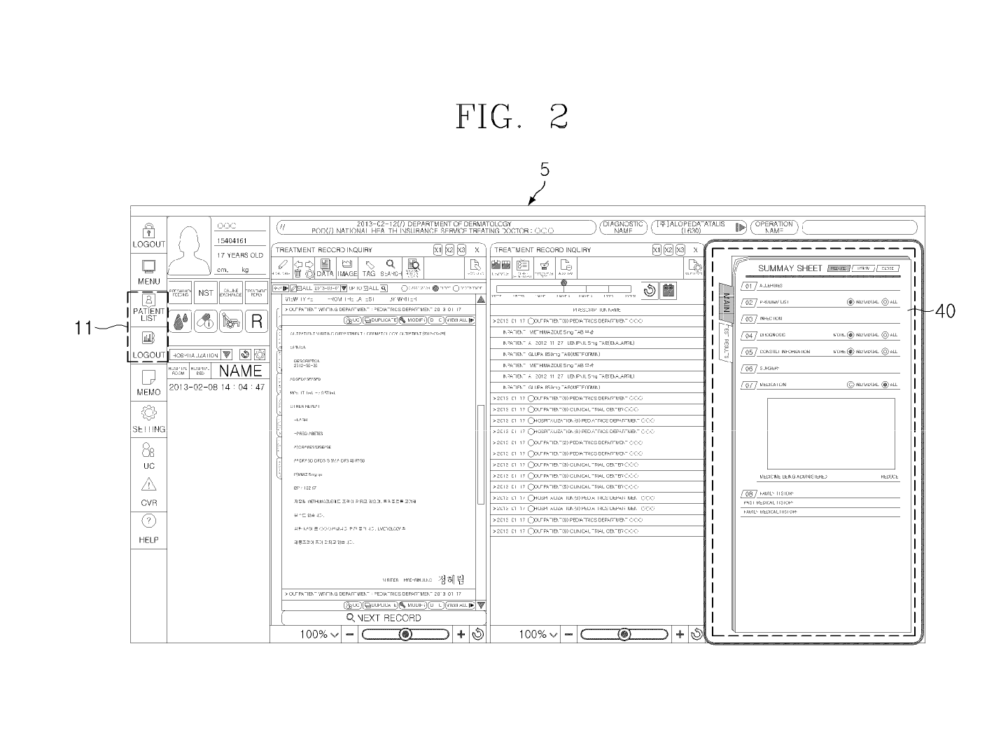

The summary sheet activation unit 10 is formed on one side of the patient information inquiry window of an EMR system, and functions to request the activation of a summary sheet. It is preferred that the summary sheet activation unit 10 according to the present invention be formed in the menu list of the patient information inquiry window 5 in the form of an activation icon 11, as shown in FIG. 2.

That is, even when medical staff performs various tasks, such as a medical record inquiry, order issuance, a test result inquiry, etc., on the patient information inquiry window 5, a summary sheet in which important information has been extracted from patient information may be provided by selecting the activation icon 11 via the summary sheet activation unit 10.

The summary sheet control unit 20 is connected to the summary sheet activation unit 10, and functions to control the task of displaying a summary sheet in response to a request for the activation of the summary sheet and the task of setting the summary sheet.

The summary sheet configuration unit 30 is connected to the summary sheet control unit 20, and functions to extract the content of the summary sheet from the patient information. It is preferred that the content of the summary sheet be set by an administrator or user in advance.

In an embodiment of the present invention, the summary sheet includes HOME and a test result page. HOME includes the allergy, problem list, infection, illness and disease, consultation, operation, prescribed medicine, medicine being administered, and family medical history information of a patient, and the test result page includes test details, issued by a medical staff member who inquires about patient information, in the form of content items.

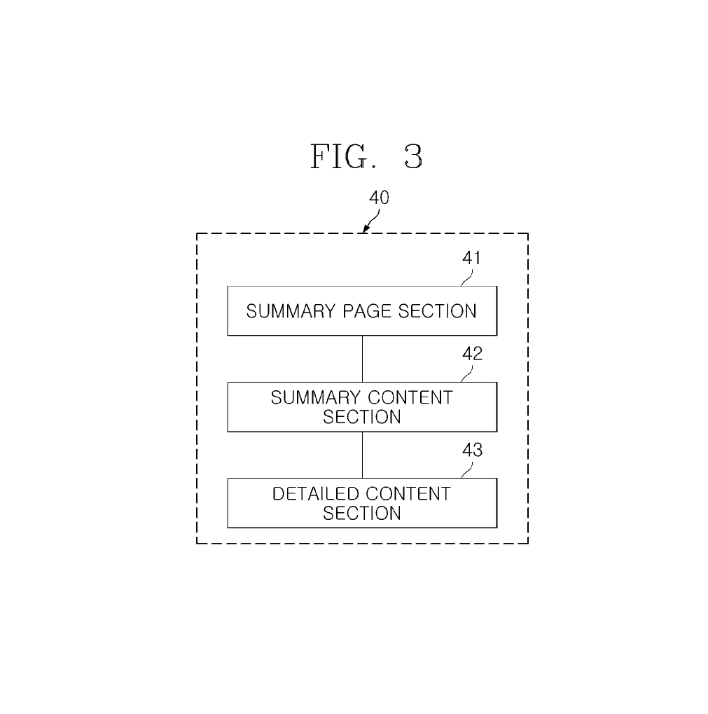

The summary sheet display unit 40 is connected to the summary sheet control unit 20, and functions to display the content of the summary sheet, extracted by the configuration unit 30, in the form of a popup window. The summary sheet display unit 40 according to the present invention includes a summary page section 41, a summary content section 42, and a detailed content section 43, as shown in FIG. 3.

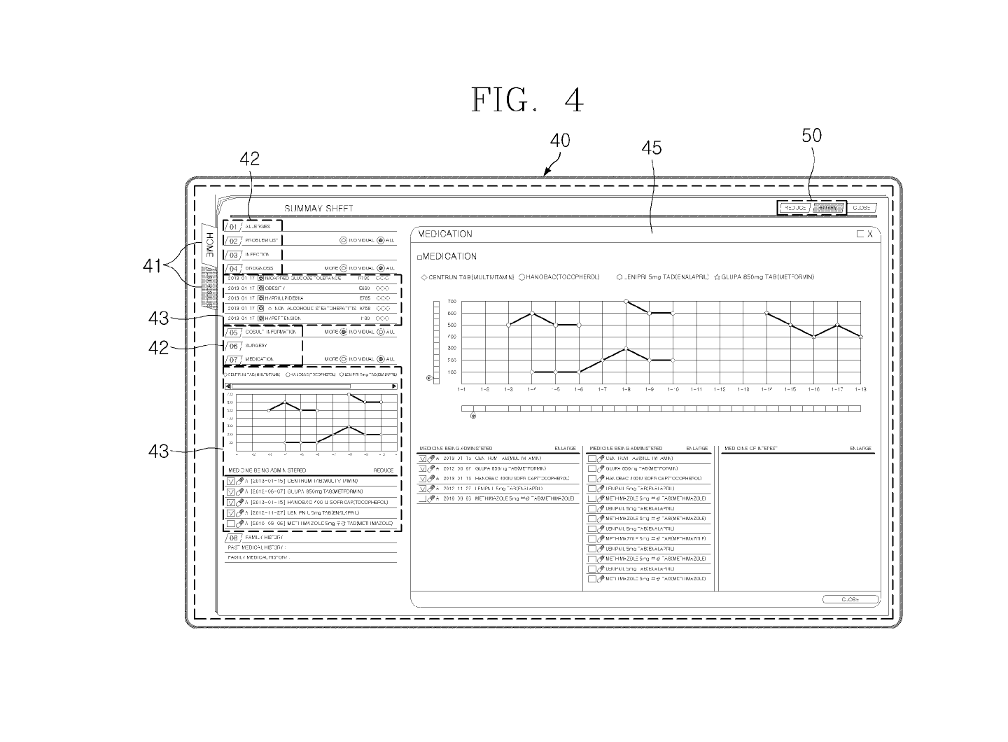

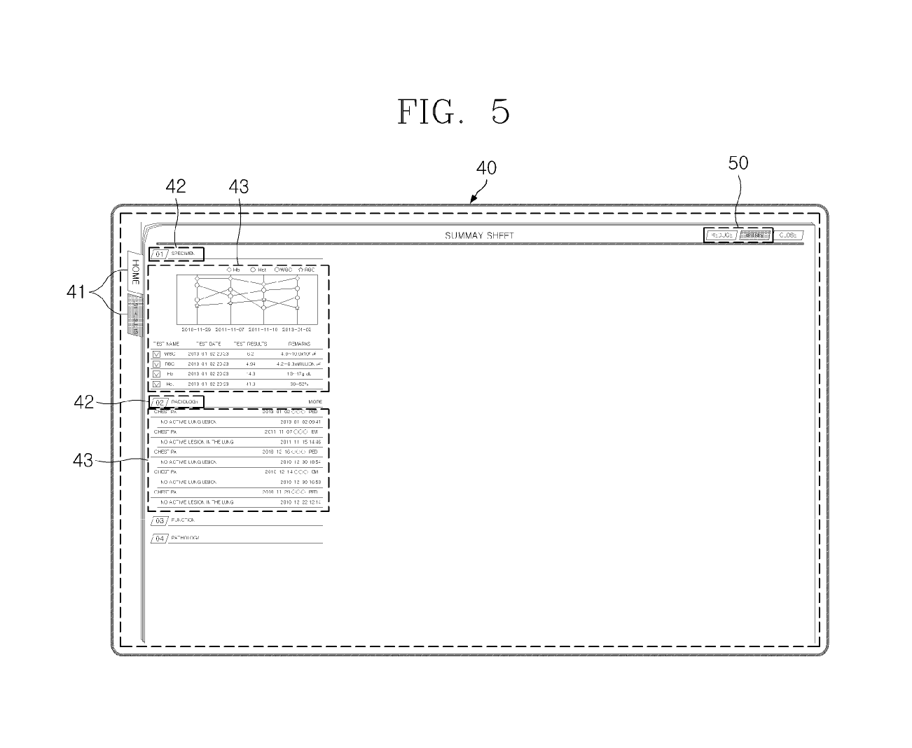

The summary page section 41 displays the page information of the summary sheet, the summary content section 42 displays at least one content item in the summary page section 41, and the detailed content section 43 displays the detailed content of the summary content section 42, as in the embodiment shown in FIGS. 4 and 5. In this case, it is preferred that the summary content section 42 display only order details or test details that have been issued by a user.

Furthermore, in the present invention, the detailed content section 43 may be displayed in the form of a detailed inquiry window 45.

The page information of the summary sheet, each page-based content information and detailed information are displayed in a single task window as described above, thereby facilitating a page-based or content-based selection task and also enabling the detailed information to be immediately checked.

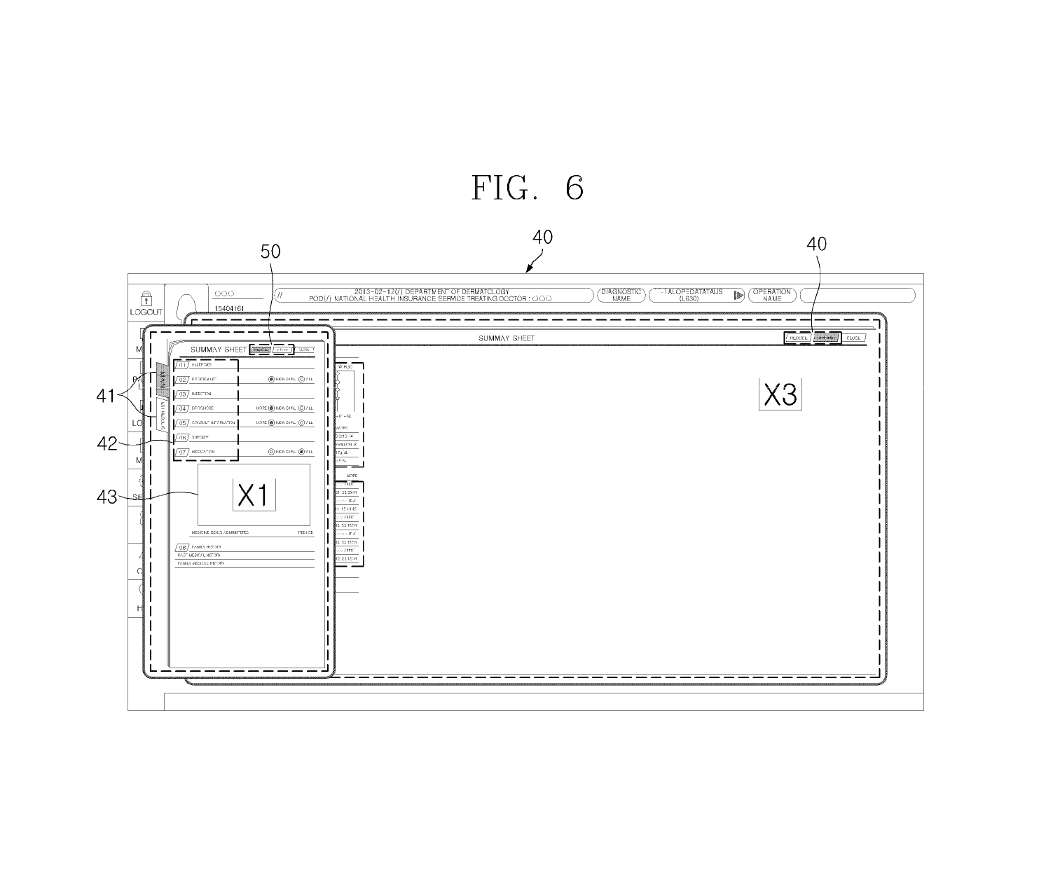

The display magnification setting unit 50 is connected to the summary sheet control unit 20, and functions to set the display magnification of the summary sheet that is displayed by the summary sheet display unit 40. In an embodiment of the present invention, the display magnification setting unit 50 sets a basic magnification of 1 for a reduction button and a magnification of 3 for a full button, as shown in FIG. 6, thereby allowing the summary sheet to be enlarged and resized when the full button is selected.

When the display magnification is changed, it is preferred that the content and detailed content of the summary sheet be rearranged in accordance with the display magnification.

The summary sheet information unit 60 is connected to the summary sheet control unit 20, and functions to store and manage the display environment information of the patient information and the summary sheet.

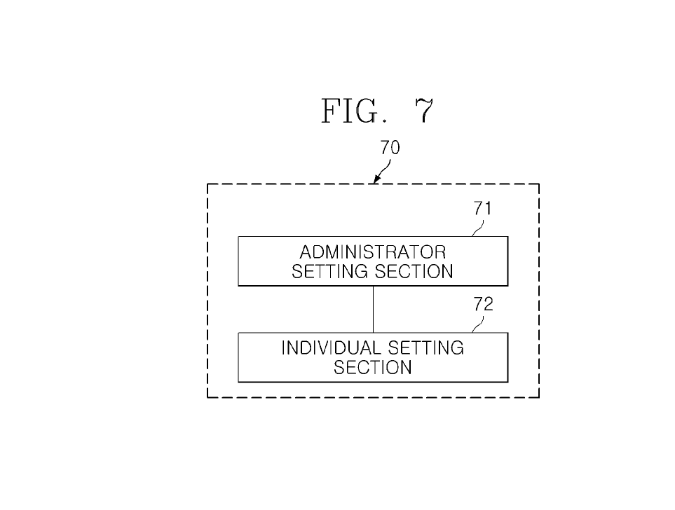

The environment setting unit 70 is connected to the summary sheet control unit 20, and functions to set the display environment of the summary sheet. The environment setting unit 70 according to the present invention includes an administrator setting section 71 and an individual setting section 72, as shown in FIG. 7.

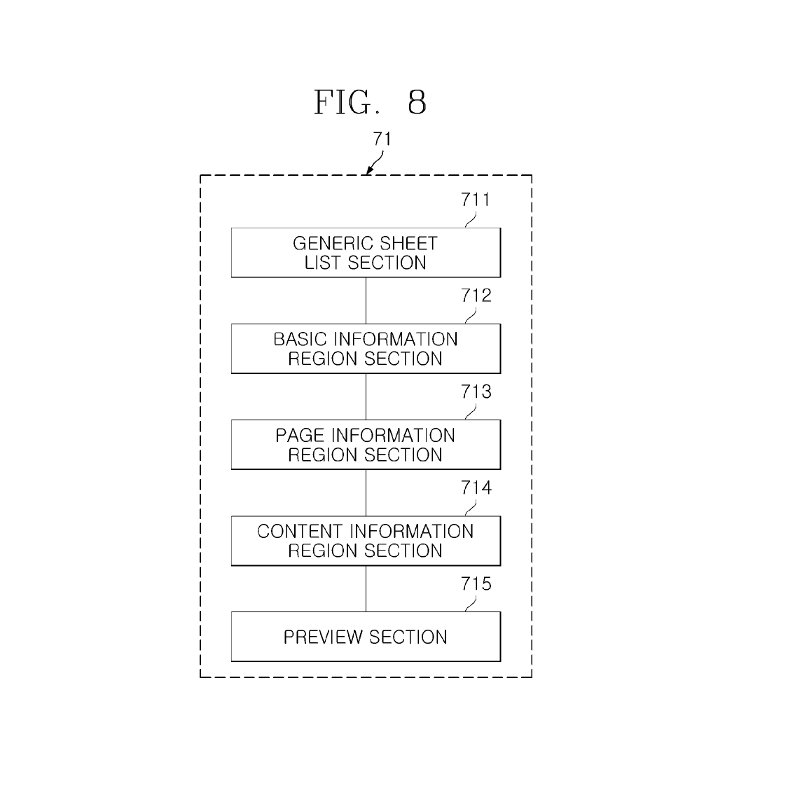

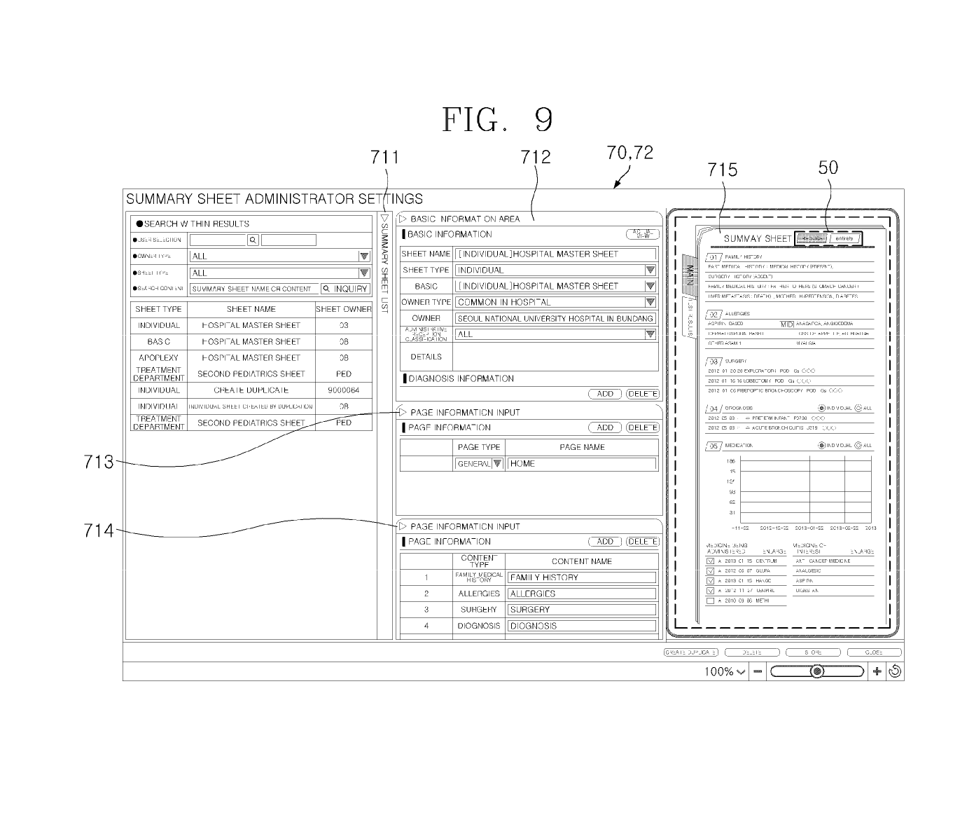

The administrator setting section 71 functions to provide a generic summary sheet commonly used inside a hospital and to set or change a customized individual summary sheet configuration. As shown in FIGS. 8 and 9, the administrator setting section 71 includes: a generic sheet list section 711 configured to provide a summary sheet commonly used inside the hospital; a basic information region section 712 configured to set basic information, such as the sheet name, sheet type, whether it is basic or not, owner and hospital administrative classification of the summary sheet; a page information region section 713 configured to set the page information of the summary sheet; a content information region section 714 configured to set one or more content items displayed in each page of the summary sheet; and a preview section 715 configured to incorporate the set details into the summary sheet.

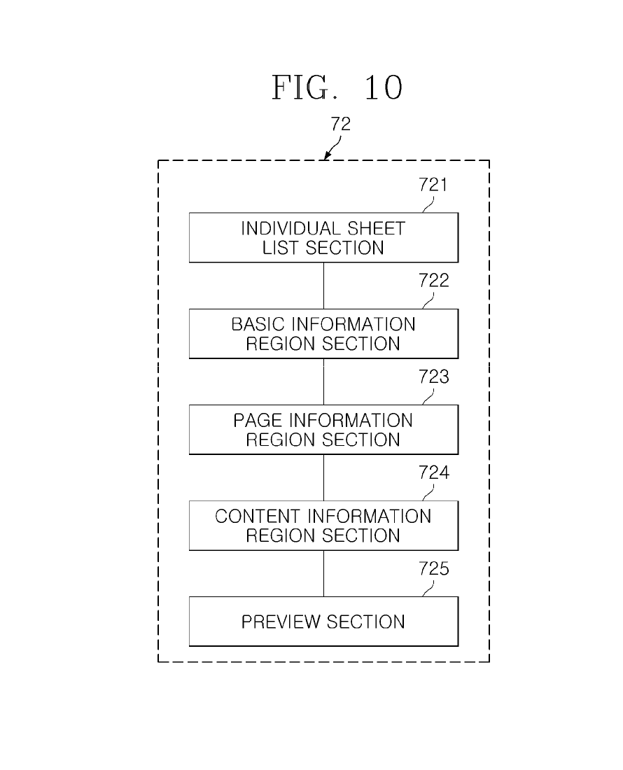

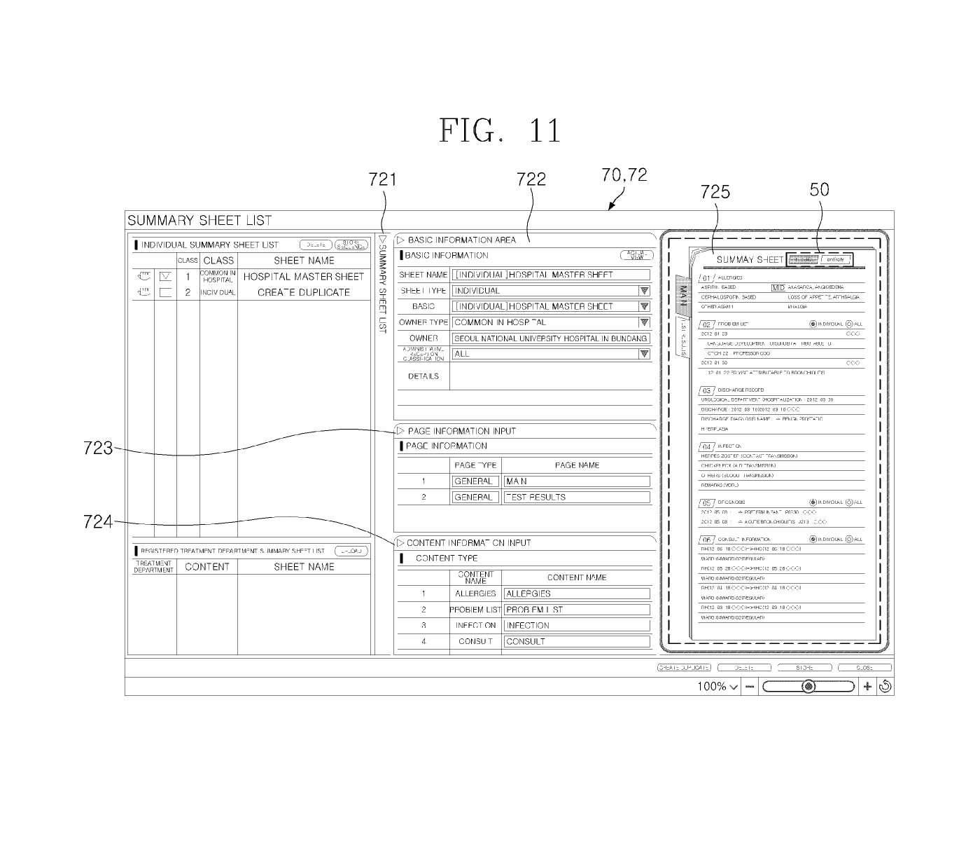

The individual setting section 72 functions to set and change an individual-based summary sheet configuration. As shown in FIGS. 10 and 11, the individual setting section 72 includes: an individual sheet list section 721 configured to manage an individual-based summary sheet list; a basic information region section 722 configured to set the basic information of an individual summary sheet; a page information region section 723 configured to set the page information of the individual summary sheet; a content information region section 724 configured to set one or more content items in each page of the individual summary sheet; and a preview section 725 configured to incorporate set details into the summary sheet.

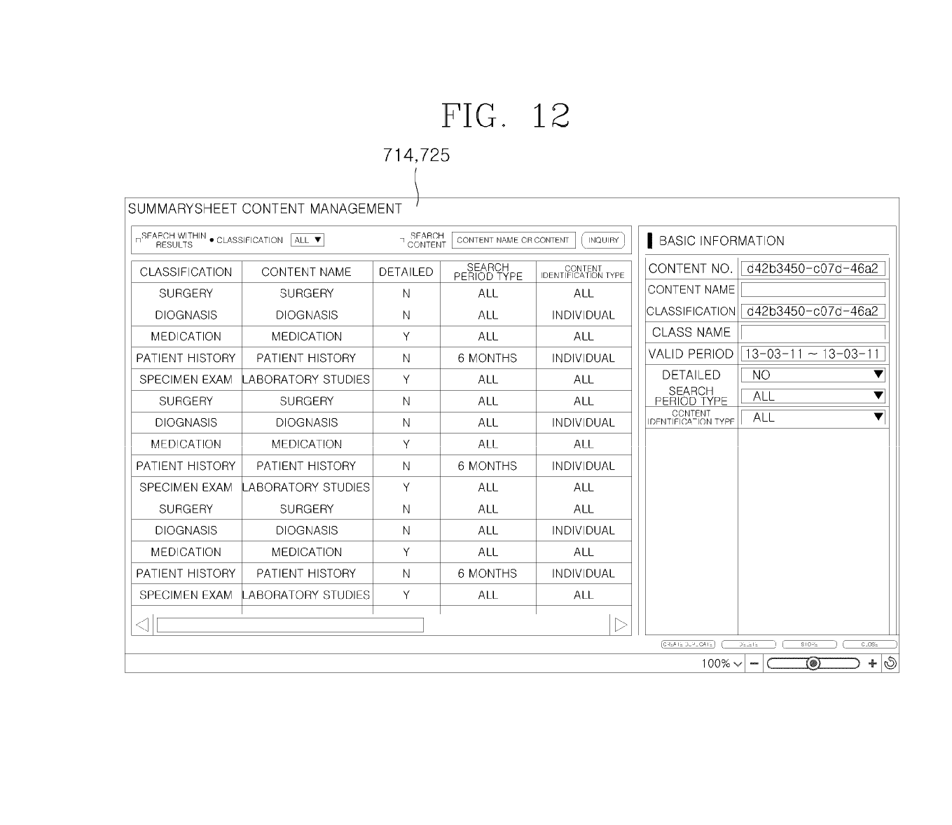

Furthermore, in an embodiment of the present invention, the content information region sections 714 and 724 receive a content classification, a content name, whether content is detailed, the type of search period, and the type of content identification, as shown in FIG. 12, and register content that will be used in the summary sheet or select content registered in a content list and incorporate the content into the summary sheet.

As described above, when the EMR system-based apparatus for managing summary sheets according to the present invention is applied, the present invention can achieve the effects of providing a summary sheet that displays the important content of patient information in a single task window in the patient information inquiry window, enabling a medical staff member to check the important content of the patient information in an integrated manner in an EMR system via the summary sheet, and also facilitating patient information and order issuance content inquiry tasks.

A method of managing summary sheets using the EMR system-based apparatus for managing summary sheets according to the present invention is described as follows:

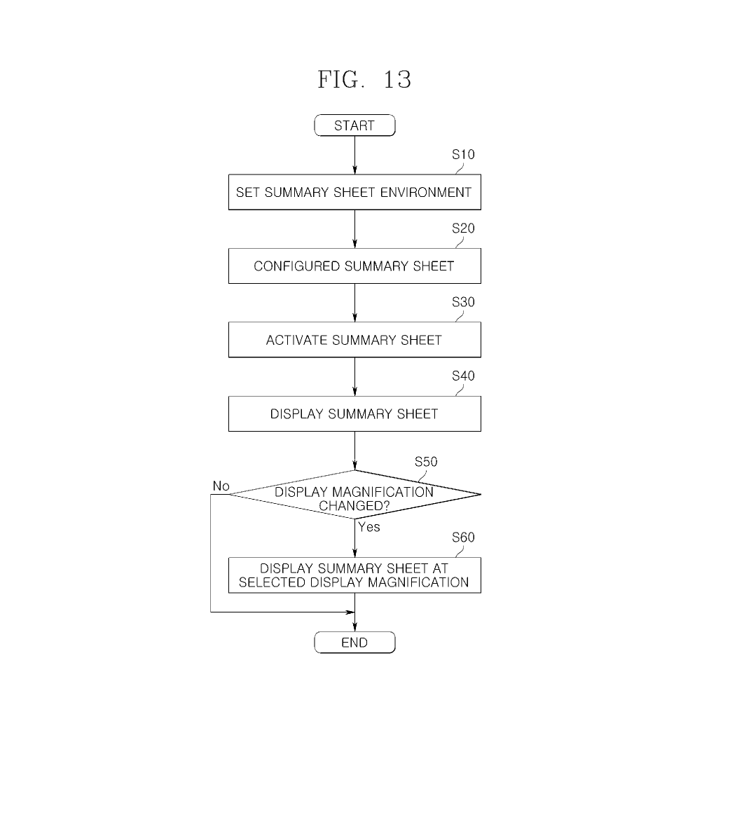

FIG. 13 is a flowchart showing the overall flow of an EMR system-based method of managing summary sheets according to the present invention. In the EMR system-based method of managing summary sheets, step S10 of setting the configuration environment of a summary sheet using the environment setting unit 70 is performed.

Step S10 refers to the step of providing a generic sheet commonly used inside a hospital or setting an individual summary sheet configuration using the administrator setting section 71, or the step of setting an individual-based summary sheet configuration using the individual setting section 72. The summary sheet includes page information and each page-based content information.

At step S10, a generic summary sheet may be shared, or a summary sheet customized for each individual may be configured.

Thereafter, when patient information is inquired about, step S20 of extracting patient information based on the environmental conditions set at step S10 and configuring a summary sheet is performed. Step S20 refers to the step of extracting patient information corresponding to the page information and the page-based content information set at step S10.

Thereafter, step S30 of requesting the activation of the display window of the summary sheet on a screen in which patient information has been inquired about using the summary sheet activation unit 10 is performed. In an embodiment of the present invention, step S30 refers to the step of selecting a summary sheet icon formed in the menu list of the patient information inquiry window.

Thereafter, step S40 of displaying the summary sheet configured at step S20 is performed using the summary sheet display unit 40. Step S40 according to the present invention refers to the step of displaying the page information of the summary sheet, each page-based content item, and the detailed content of summary content in a single task window.

Thereafter, step S50 of checking whether the display magnification of the display magnification setting unit has been changed using the summary sheet control unit 20 is further included. If it is found at step S50 that the display magnification has been changed, step S60 of resizing the summary sheet at a selected display magnification and rearranging and displaying the content of the summary sheet is performed.

Via steps S50 and S60, the content of the summary sheet is rearranged and displayed in accordance with the selected display magnification, thereby improving the identification of summary information.

As described above, when the EMR system-based method of managing summary sheets is applied, a generic summary sheet is shared or a summary sheet customized for each individual is configured, thereby providing the effect of checking the important information of a patient in an integrated manner without the task of individually inquiring about the important information of the patient.

Although the above description has been given by way of the embodiments of the present invention, the technical spirit of the present invention is not limited to the embodiments. The present invention may be implemented as various EMR system-based apparatuses and methods for managing summary sheets within the range that does not depart from the technical spirit of the present invention.

1. An electronic medical record (EMR) system-based apparatus for managing summary sheets, comprising:
a summary sheet activation unit formed on one side of a patient information inquiry window of an EMR system, and configured to request activation of a summary sheet;
a summary sheet control unit configured to control a task of displaying the summary sheet and a task of setting the summary sheet in response to the request for the activation of the summary sheet;
a summary sheet configuration unit configured to extract the content of the summary sheet from patient information in accordance with the setting of the summary sheet; and
a summary sheet display unit configured to display the content of the summary sheet, extracted by the summary sheet configuration unit, in a popup window form.

2. The EMR system-based apparatus of claim 1, wherein the summary sheet activation unit is formed in a menu list of the patient information inquiry window in the form of a specific icon.

3. The EMR system-based apparatus of claim 1, wherein the summary sheet display unit comprises:
a summary page section configured to display page information of the summary sheet;
a summary content section configured to display at least one content item in the summary page section; and
a detailed content section configured to display detailed content of the summary content section.

4. The EMR system-based apparatus of claim 1, further comprising a display magnification setting unit connected to the summary sheet control unit, and configured to set display magnification of the summary sheet displayed by the summary sheet display unit.

5. The EMR system-based apparatus of claim 1, further comprising an environment setting unit connected to the summary sheet control unit, and configured to set a display environment of the summary sheet.

6. The EMR system-based apparatus of claim 5, wherein the environment setting unit comprises:
an administrator setting section configured to provide a generic summary sheet commonly used inside a hospital, and to set and change a customized individual summary sheet configuration; and
an individual setting section configured to set and change an individual-based summary sheet configuration.

7. The EMR system-based apparatus of claim 5, further comprising a summary sheet information unit connected to the summary sheet control unit, and configured to store and manage display environment information of the patient information and the summary sheet.

8. An electronic medical record (EMR) system-based method of managing summary sheets, comprising the steps of:
(a) setting a configuration environment of a summary sheet using an environment setting unit;
(b) upon inquiry about patient information, extracting patient information and configuring a summary sheet in accordance with the environmental conditions set at step (a);
(c) requesting activation of a display window for the summary sheet using a summary sheet activation unit in a screen in which the patient information has been inquired about; and
(d) displaying the summary sheet configured at step (b) using a summary sheet display unit.

9. The EMR system-based method of claim 8, wherein step (a) is any one of step (a-1) of providing a generic sheet commonly used inside a hospital or setting an individual summary sheet configuration using an administrator setting section, and step (a-2) of setting an individualized summary sheet configuration using an individual setting section.

10. The EMR system-based method of claim 8, further comprising:
after step (d), step (e) of checking whether, display magnification of a display magnification setting unit has been changed using a summary sheet control unit; and
if it is found at step (e) that the display magnification has been changed, step (f) of resizing the summary sheet at a selected display magnification, and rearranging and displaying content of the summary sheet.

11. The EMR system-based method of claim 8, wherein step (c) is the step of selecting a summary sheet icon formed in a menu list of a patient information inquiry window.

12. The EMR system-based method of claim 8, wherein step (d) is the step of displaying page information of the summary sheet, each page-based content item, and details of summary content section in a single task window.
